(19) United States
(12) Patent Application Publication
(10) Pub. No.: US 2011/0229158 A1
(43) Pub. Date: Sep. 22, 2011

(54) IMAGE FORMING DEVICE WHICH INCLUDES AT LEAST ONE MOTOR THAT GENERATES MOTIVE POWER BY CURRENT

(75) Inventors: Shinichi YABUKI, Toyokawa-shi (JP); Hironori Akashi, Okazaki-shi (JP); Kunio Furukawa, Toyokawa-shi (JP)

(73) Assignee: Konica Minolta Business Technologies, Inc., Tokyo (JP)

(21) Appl. No.: 13/048,571

(22) Filed: Mar. 15, 2011

(30) Foreign Application Priority Data
Mar. 18, 2010 (JP) 2010-062629

(51) Int. Cl. G03G 15/08; G03G 21/00

(52) U.S. Cl. 399/27; 399/36

(57) ABSTRACT

An image forming device includes a motor which generates motive power by current, a component driven by the motive power of the motor, and a motor current waveform determining unit which determines a condition of the image forming device on the basis of a current waveform of the current flowing through the motor while the motor is being driven. Accordingly, the image forming device which is capable of determining the condition of the device while suppressing an increase in the number of components and preventing reduction of productivity can be provided.

This application is based on Japanese Patent Application No. 2010-062629 filed with the Japan Patent Office on Mar. 18, 2010, the entire content of which is hereby incorporated by reference.

### BACKGROUND OF THE INVENTION

1. Field of the Invention

The present invention relates to image forming devices and methods for controlling the image forming devices. More particularly, the present invention relates to an image forming device which uses a motor to drive a component, and a method for controlling the image forming device.

2. Description of the Related Art

Electrophotographic image forming devices include a multi-function peripheral (MFP) provided with the scanner function, facsimile transmitting/receiving function, copying function, function as a printer, data communicating function, and server function, a facsimile machine, a copier, a printer, and the like.

Such an image forming device primarily includes an image forming unit and a paper transport unit. The paper transport unit transports a sheet of paper from a paper feed tray to the image forming unit, and transports a sheet of paper onto which an image has been formed, to a paper discharge tray. The image forming unit forms a toner image on an image carrier, and transfers and presses the toner image onto a transfer material (e.g. a sheet of paper) to thereby form an image on the transfer material. The image forming unit and the paper transport unit are made up of various components, which are primarily driven by motors.

Load applied to a motor built in the image forming device varies depending on various factors including the remaining amount of toner (also referred to as the “toner level”), the size of paper to be transported, the quality of an image to be formed, and the like. Such variation of the load will affect the condition of the image forming device.

In order to detect variation of load in an image forming device, a sensor or other component may be used to check the condition of the load. This method, however, requires a separate component for checking the load condition, leading to an increase in the number of components and, hence, cost.

A technique enabling detection of the condition of an image forming device without using a sensor or other component is disclosed for example in Document 1 below. In Document 1, a developing roller included in a development device is driven by a stepper motor. The stepper motor is driven in the state where an output current of the stepper motor is set to a low current, and the toner level in the development device is detected in accordance with the presence/absence of loss of synchronism of the stepper motor.
[Document 1] Japanese Patent Application Laid-Open No. 2007-219247

With the technique disclosed in Document 1, however, it is necessary to cause the stepper motor to lose synchronization in order to check the load condition. When the stepper motor loses synchronization, printing will have to be stopped, causing reduction of productivity as well as deterioration of usability for a user.

### SUMMARY OF THE INVENTION

In view of the foregoing, an object of the present invention is to provide an image forming device which is capable of determining the condition of the image forming device while suppressing an increase in the number of components and preventing reduction of productivity, and a method for controlling the image forming device.

An image forming device according to an aspect of the present invention is an image forming device including at least one motor configured to generate motive power by current, which device includes: a component driven by the motive power of the motor; and a determining unit configured to determine a condition of the image forming device on the basis of a current waveform of current flowing through the motor while the motor is being driven.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a side view of an image forming device according to an embodiment of the present invention;

FIG. 2 is a block diagram showing a configuration of a control circuit in the image forming device;

FIG. 3 is a perspective view showing a configuration of toner bottles and their surroundings;

FIG. 4 shows, by way of example, a motor current waveform which is set for the case where maximum load is applied to the motor while the motor is driving a component;

FIG. 5 shows, by way of example, a motor current waveform which is set for the case where minimum load is applied to the motor while the motor is driving a component;

FIG. 6 shows, by way of example, a motor current waveform which is set for the case where load of a reference magnitude is applied to the motor while the motor is driving a component;

FIG. 7 is a block diagram showing a configuration for detecting a waveform of current flowing through a toner bottle drive motor to confirm the toner level in the toner bottle, and for displaying a message regarding preparation of a new toner bottle to a user;

FIG. 8 is a block diagram showing a configuration for detecting a waveform of current flowing through a toner hopper drive motor to confirm the toner level in the hopper, and for displaying a message regarding replacement of the toner bottle to a user;

FIG. 9 shows, by way of example, changes over time of the current waveform detected while the stepper motor is being driven;

FIG. 10 schematically shows a load determination current waveform;

FIG. 11 shows a stepper motor drive circuit included in a device control unit 40;

FIG. 12 illustrates how an inflection point occurs in accordance with load;

FIG. 13 illustrates a specific example of a method for detecting an inflection point; and

FIG. 14 is a flowchart of a toner level detecting process.

### DESCRIPTION OF THE PREFERRED EMBODIMENTS

Hereinafter, an embodiment of the present invention will be described with reference to the accompanying drawings.

Firstly, an overall configuration of the image forming device according to the embodiment will be described.

### [Overall Configuration of Image Forming Device]

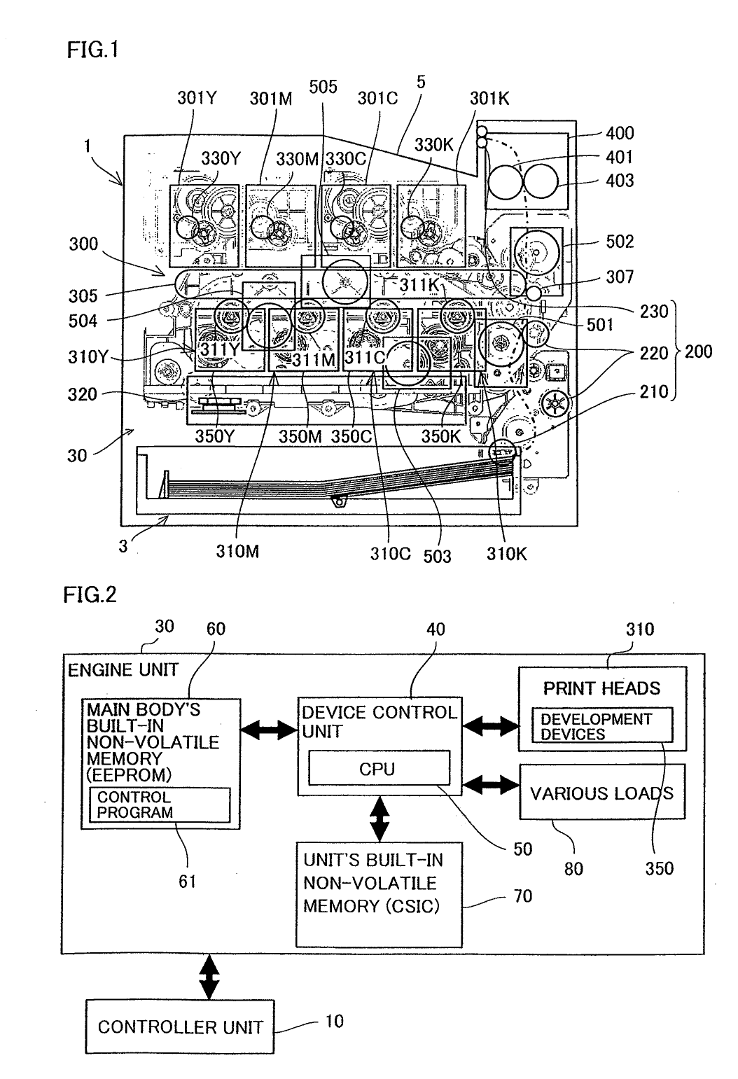

Referring to FIG. 1, an image forming device 1 includes a paper cassette 3, a catch tray 5, and an engine unit 30.

Paper cassette 3 is disposed at a bottom part of image forming device 1 and is removable from the housing of image forming device 1. During printing, a sheet loaded into a paper cassette 3 is fed from paper cassette 3, one by one, to engine unit 30.

Catch tray 5 is disposed on top of the housing of image forming device 1. A sheet on which an image has been formed by engine unit 30 is discharged from inside the housing to catch tray 5.

Engine unit 30 is disposed within the housing of image forming device 1. Engine unit 30 generally includes a paper transport unit 200, a toner image forming unit 300, and a fixing device 400. Engine unit 30 is configured to combine images in four different colors, i.e. Y, M, C, and K, using a so-called tandem system, thereby forming a color image on a sheet.

Paper transport unit 200 is composed of a feed roller 210, a transport roller 220, a discharge roller 230, and other components. In each of transport roller 220 and discharge roller 230, two opposite rollers, for example, that sandwich a sheet therebetween are rotated to thereby transport the sheet.

Feed roller 210 feeds one sheet at a time from paper cassette 3. The sheet is fed into the interior of the housing of image forming device 1 by feed roller 210. Transport roller 220 transports the sheet fed by feed roller 210 to toner image forming unit 300. Further, transport roller 220 transports the sheet that has passed fixing device 400 to discharge roller 230. Discharge roller 230 discharges the sheet that has been transported by transport roller 220 to the outside of the housing of image forming device 1.

It should be noted that paper transport unit 200 may include other rollers used to transport a sheet or for other purposes.

Toner image forming unit 300 is composed of four toner bottles (the toner bottle is an example of a replenishing mechanism) 301Y, 301M, 301C, and 301K for different colors (hereinafter, they may also be collectively referred to as “toner bottle 301”), an intermediate transfer belt 305, a transfer roller 307, four print heads 310Y, 310M, 310C, and 310K (hereinafter, they may also be collectively referred to as “print head 310”), a laser scanning unit 320, and other components.

Yellow toner bottle 301Y, magenta toner bottle 301M, cyan toner bottle 301C, and black toner bottle 301K store yellow (Y), magenta (M), cyan (C), and black (K) toners, respectively. Toner bottles 301Y, 301M, 301C, and 301K are rotated respectively by drive motors 330Y, 330M, 330C, and 330K (hereinafter, they may also be collectively referred to as “drive motor 330”) to replenish toners stored therein to the corresponding print heads 310. The toner is replenished through a hopper (a toner hopper) (not shown) when the toner level becomes low in any of development devices 350 of print heads 310.

Intermediate transfer belt 305 forms a loop and is laid around two rollers (not shown). Intermediate transfer belt 305 is rotated in a synchronized manner with paper transport unit 200. Transfer roller 307 is positioned to face the portion of intermediate transfer belt 305 that is in contact with one roller. The distance between transfer roller 307 and intermediate transfer belt 305 is regulated by a pressing/separating mechanism. A sheet is sandwiched between, and transported by, intermediate transfer belt 305 and transfer roller 307.

Each print head 310 includes a photoreceptor drum 311, a development device 350, a cleaner, an electrifying device, and other components. Photoreceptor drum 311 refers to photoreceptor drums 311Y, 311M, 311C, and 311K which are provided for print heads 310Y, 310M, 310C, and 310K, respectively. Development device 350 refers to development devices 350Y, 350M, 350C, and 350K which are provided for photoreceptor drums 311Y, 311M, 311C, and 311K, respectively. Yellow print head 310Y, magenta print head 310M, cyan print head 310C, and black print head 310K are arranged so as to form Y, M, C, and K images, respectively. Print heads 310 are arranged side by side directly below intermediate transfer belt 305. Laser scanning unit 320 is located so that it can scan photoreceptor drums 311 with a laser beam.

In toner image forming unit 300, laser scanning unit 320 forms latent images on photoreceptor drums 311, which have been electrified in a unified manner by the electrifying device, on the basis of image data for colors Y, M, C, and K. Development devices 350 deposit the toners of the corresponding colors onto the corresponding photoreceptor drums 311 on which the latent images have been formed, to thereby form toner images on photoreceptor drums 311 (development). Photoreceptor drums 311 transfer the toner images onto intermediate transfer belt 305 to form, on intermediate transfer belt 305, a mirror image of the toner image, as a combination of the toner images of the four colors, which is to be formed on a sheet (primary transfer). Then, transfer roller 307, to which a high voltage has been applied, transfers the toner image formed on intermediate transfer belt 305 onto the sheet, thereby forming a toner image on the sheet (secondary transfer).

Fixing device 400 has a heating roller 401 and a pressure roller 403. Fixing device 400 transports a sheet, on which a toner image is formed, by means of heating roller 401 and pressure roller 403 that work together to sandwich the sheet, and heats and presses it together. In this way, fixing device 400 melts the toner adhering to the sheet and fixes it on the sheet, thereby forming an image on the sheet. The sheet that has passed fixing device 400 is discharged by discharge roller 230 from the housing of image forming device 1 onto catch tray 5.

Engine unit 30 includes, for example, a main motor 501, a fixing motor 502, a black development motor 503, a color development motor 504, a color photoreceptor motor 505, and other motors which drive corresponding components in the image forming device (hereinafter, these motors may also be simply referred to as “motors 501-505”). Main motor 501 enables sheet transporting, from the feeding step to the transfer step, and drives intermediate transfer belt 305 and black photoreceptor drum 311K. Fixing motor 502 drives fixing device 400. Black development motor 503 drives black print head 310K including black development device 350K. Color development motor 504 drives print heads 310Y, 310M, and 310C including yellow, magenta, and cyan development devices 350. Color photoreceptor motor 505 drives yellow, magenta, and cyan photoreceptor drums 311Y, 311M, and 311C. Besides motors 501-505, a pressing/separating motor for changing pressure in holding the sheet in transfer roller 307 or fixing device 400, for example, may be provided.

FIG. 2 is a block diagram showing a configuration of a control circuit included in the image forming device.

Referring to FIG. 2, a control circuit of image forming device 1 is primarily made up of components included in a controller unit 10 and components included in engine unit 30. Controller unit 10 controls overall operations of image forming device 1. Engine unit 30 is connected to controller unit 10, and transmits and receives necessary information, such as a dot count, to and from controller unit 10.

Engine unit 30 includes, besides the above-described components, a device control unit 40, a main body's built-in non-volatile memory 60, a unit's built-in non-volatile memory 70, and various loads 80 (each load is an example of a component). Various loads 80 include drive motor 330 for toner bottle 301 and a drive motor for a hopper. Various loads 80 further include motors 501-505 for sheet transporting, toner replenishing, image forming, and the like, and a heater (not shown) in fixing device 400. Print heads 310 include development devices 350 described above.

Device control unit 40 includes a central processing unit (CPU) 50. Device control unit 40 also includes a read only memory (ROM) (not shown), a random access memory (RAM) (not shown), and other components. CPU 50 controls operations of main body's built-in non-volatile memory 60, unit's built-in non-volatile memory 70, various loads 80, print heads 310, and other components.

Main body's built-in non-volatile memory 60 may be an electrically erasable and programmable ROM (EEPROM), for example, which is used as a storage medium. Main body's built-in non-volatile memory 60 is connected to CPU 50. Main body's built-in non-volatile memory 60 is capable of storing various kinds of information including data measured or calculated by CPU 50, setting information for image forming device 1, and others. A control program 61 is stored in main body's built-in non-volatile memory 60. CPU 50 for example reads control program 61 from main body's built-in non-volatile memory 60 and executes the program so as to control the operations of engine unit 30 and the like.

Main body's built-in non-volatile memory 60 is not restricted to the EEPROM. As main body's built-in non-volatile memory 60, a hard disk drive (HDD) may be provided in place of, or in addition to, the EEPROM. Control program 61 does not necessarily have to be stored in main body's built-in non-volatile memory 60.

Unit's built-in non-volatile memory 70 may be a customer specific integrated circuit (CSIC), for example. Unit's built-in non-volatile memory 70 is provided for consumables such as print head 310. For example, unit's built-in non-volatile memory 70 is provided for each print head 310, or, for each of Y, M, C, and K.

Unit's built-in non-volatile memory 70 records various information including the number of sheets of paper printed using the corresponding print head 310, the number of revolutions of photoreceptor drum 311 or the like, data about consumables, information regarding the manufacturer of that print head 310, and others. CPU 50 reads the information recorded on unit's built-in non-volatile memory 70 to perform various kinds of controls in accordance with the read information. For example, CPU 50 notifies a user of the necessity of replacement of print head 310 or the like.

### [Configuration of Toner Bottles and Hoppers]

Hereinafter, a configuration of toner bottles and hoppers will be described.

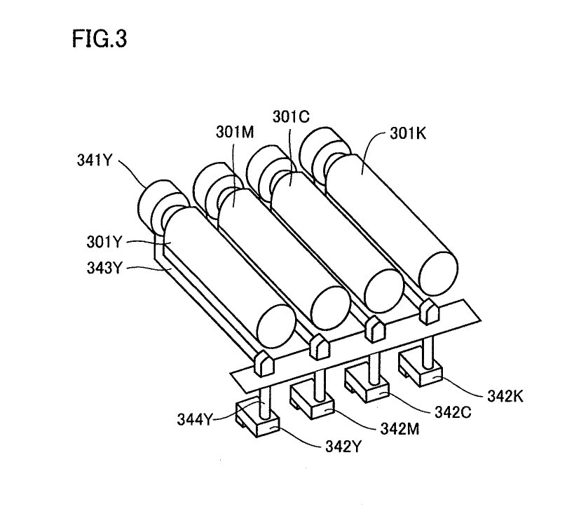

FIG. 3 is a perspective view showing a configuration of toner bottles and their surroundings.

Referring to FIG. 3, toner bottles 301Y, 301M, 301C, and 301K are arranged such that their bottoms are on the front side in FIG. 3 and their toner outlet openings are at the back in FIG. 3. The configuration for transporting the toner is essentially the same for each of the four colors, and thus, toner bottle 301Y will now be described representatively.

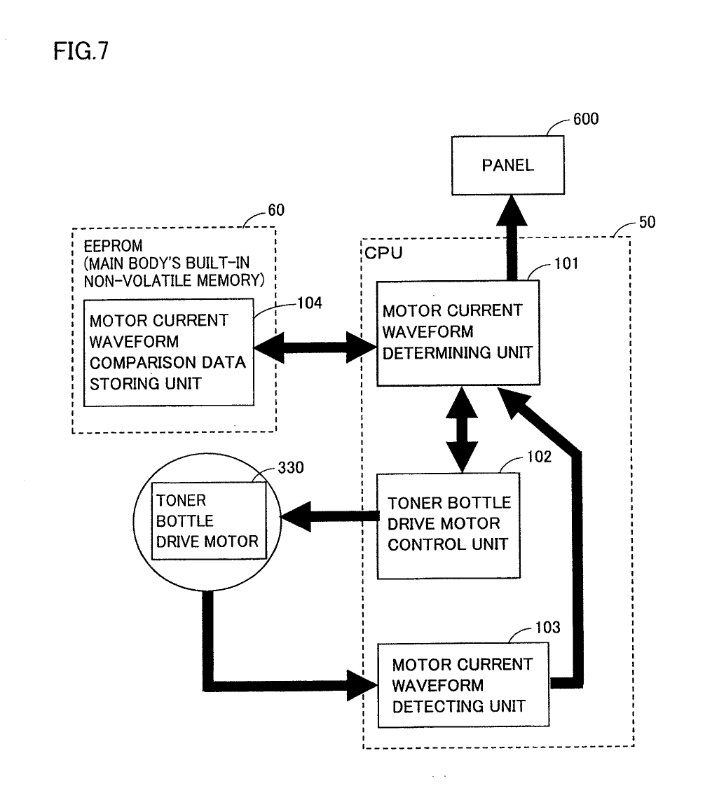

Toner bottle 301Y is rotated by motive power of drive motor 330Y (FIGS. 1 and 7) in the state where it is held by a bottle holding unit 341Y. The toner contained in toner bottle 301Y is discharged from the outlet opening, located at the head of the rotating toner bottle 301Y, and transported through transport paths 343Y and 344Y to a hopper 342Y by screws arranged inside the transport paths. Hopper 342Y is in contact with development device 350Y. It is noted that the toner does not necessarily have to be transported by rotation of screws. Any other techniques well known in the art, such as generation of airflow, may be adopted as appropriate.

Specifically, as the toner contained in toner bottle 301Y is discharged from the outlet opening of the bottle, it is transported through transport path 343Y toward the front side of FIG. 3. Thereafter, the toner is passed from transport path 343Y to transport path 344Y, through which the toner is transported downward in FIG. 3. Finally, the toner is fed to hopper 342Y which is connected at an obliquely downward end.

Hoppers 342Y, 342M, 342C, and 342K (hereinafter, they may also be collectively referred to as “hopper 342”) serve to pass the toners of the corresponding colors from toner bottles 301Y, 301M, 301C, and 301K to development devices 350Y, 350M, 350C, and 350K, respectively. That is, hopper 342 temporarily stores the toner received from toner bottle 301, and feeds the stored toner to development device 350.

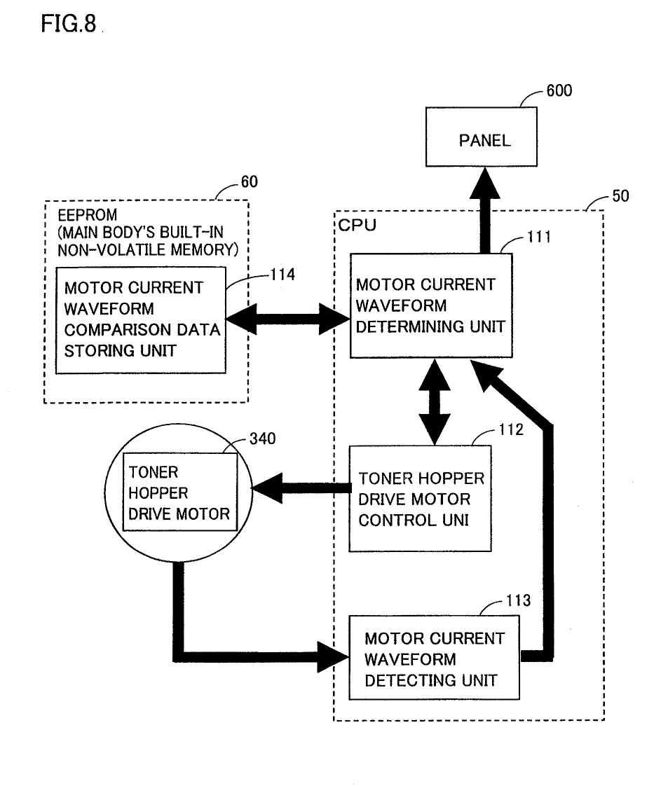

Specifically, hopper 342 has an agitator (not shown) mounted therein. As the agitator is rotated by motive power of drive motor 340 (FIG. 8), the rotation of the agitator stirs the toner inside hopper 342, and the toner is transported toward development device 350.

In the present embodiment, motors 501-505, drive motor 330 for toner bottle 301, drive motor 340 for hopper 342, and other motors generate motive power by current so as to drive the corresponding components in image forming device 1 by the generated motive power.

### [Motor Current Waveform]

As described above, image forming device 1 includes various kinds of motors, which are preferably stepper motors. Examples of a waveform (or, a current waveform) of the current flowing through a stepper motor while the motor is being driven will now be described.

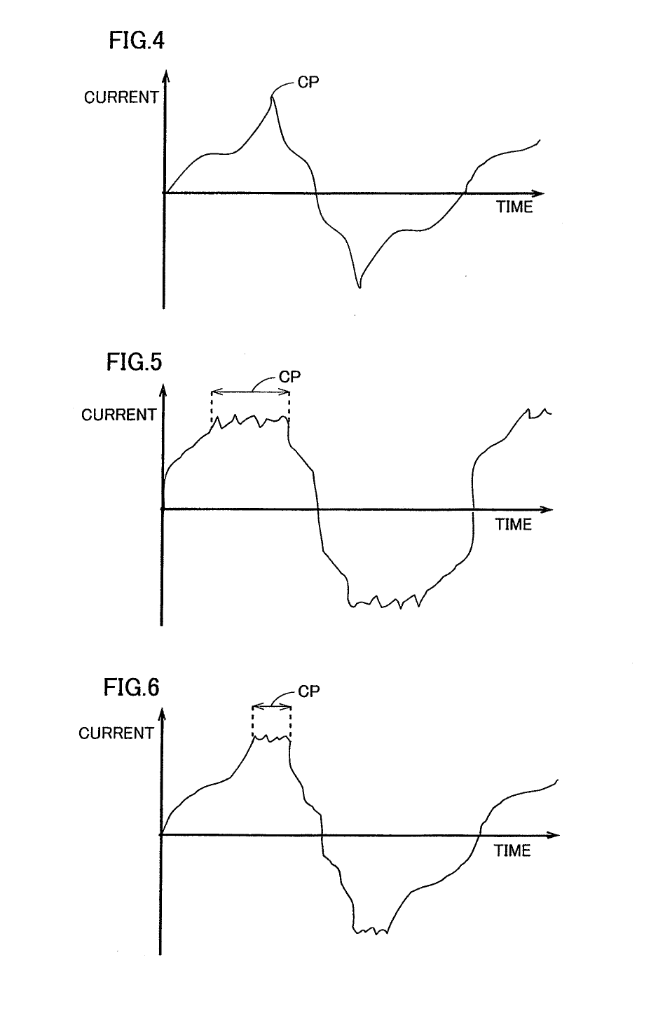

FIG. 4 shows, by way of example, a motor current waveform which is set for the case where maximum load is applied to the motor while the motor is driving a component. FIG. 5 shows, by way of example, a motor current waveform which is set for the case where minimum load is applied to the motor while the motor is driving a component. FIG. 6 shows, by way of example, a motor current waveform which is set for the case where load of a reference magnitude is applied to the motor while the motor is driving a component.

The motor current waveform is set such that the current waveform takes the form as shown in FIG. 4 in the case where the load applied to the motor while the motor is driving a component is maximum (hereinafter, this current waveform may be called a “maximum load current waveform”). In the maximum load current waveform shown in FIG. 4, the period during which a constant current is flowing (or, a constant-current chopping period CP) is very short. Further, the motor current waveform is set such that it takes the form as shown in FIG. 5 in the case where the load applied to the motor while the motor is driving a component is minimum (hereinafter, this current waveform may be called a “minimum load current waveform”). In the minimum load current waveform shown in FIG. 5, the constant-current chopping period CP is very long. Still further, the motor current waveform is set such that it takes the form as shown in FIG. 6 in the case where the motor is driving a load having a reference magnitude (hereinafter, this current waveform may be called a “load determination current waveform”). The load determination current waveform is used as a reference for determining the magnitude of the load that is applied to the motor while the motor is being driven. In the load determination current waveform shown in FIG. 6, the constant-current chopping period CP has a length longer than that of the maximum load current waveform shown in FIG. 4 and shorter than that of the minimum load current waveform shown in FIG. 5. The maximum load current waveform, the minimum load current waveform, and the load determination current waveform are stored for example in main body's built-in non-volatile memory 60.

As described above, the motor current waveform is set to vary in accordance with the load (torque, load torque) at the time when the motor drives a component. The motor current waveform is set to change between the state of driving maximum load and the state of driving minimum load. Particularly, the motor current waveform is preferably set such that it changes significantly between the condition where the maximum load is driven and the condition where the minimum load is driven. The motor current waveform may be adjusted by changing, for example, a structure of the motor, setting of a driver for driving the motor, and the like.

It is noted that the current waveform to be set does not necessarily have to be the maximum load current waveform. It may be a current waveform corresponding to the case where load having a magnitude greater than the reference magnitude is applied. Similarly, the current waveform to be set does not necessarily have to be the minimum load current waveform. It may be a current waveform corresponding to the case where load having a magnitude smaller than the reference magnitude is applied.

In the present embodiment, the toner level in toner bottle 301 or hopper 342 is detected on the basis of a waveform of the current flowing through drive motor 330 for toner bottle 301 or drive motor 340 for hopper 342 while that motor is being driven.

### [Configuration for Detecting Toner Level in Toner Bottle]

Hereinafter, a configuration for detecting the toner level in toner bottle 301 will be described.

When the toner remaining in any of development devices 350 decreases as a result of formation of images, the toner stored in toner bottle 301 of the corresponding color is replenished to that development device 350 via hopper 342. The toner is replenished as appropriate in accordance with the toner concentration within development device 350, the number of printed sheets of paper, and the like. As the toner is replenished to development device 350, the toner remaining in toner bottle 301 is reduced in amount. As the toner level in toner bottle 301 decreases, the weight of toner bottle 301 decreases correspondingly, leading to a reduction in magnitude of the load applied to drive motor 330 which is rotating toner bottle 301. This allows CPU 50 to detect the toner level in toner bottle 301 on the basis of a waveform of the current flowing through drive motor 330. In the case where the toner level in toner bottle 301 is a predetermined level or less, CPU 50 causes a message prompting a user to prepare a new toner bottle to be displayed.

FIG. 7 is a block diagram showing a configuration for detecting a waveform of the current flowing through a toner bottle drive motor to confirm the toner level in the toner bottle, and for displaying a message regarding preparation of a new toner bottle to a user.

Referring to FIG. 7, image forming device 1 further includes a panel 600 for use in displaying a message to a user.

CPU 50 includes a motor current waveform determining unit (hereinafter, also referred to as “waveform determining unit”) 101, a toner bottle drive motor control unit (hereinafter, also referred to as “motor control unit”) 102, and a motor current waveform detecting unit (hereinafter, also referred to as “waveform detecting unit”) 103.

Main body's built-in non-volatile memory 60 includes a motor current waveform comparison data storing unit (hereinafter, also referred to as “data storing unit”) 104. Data storing unit 104 stores data of a load determination current waveform which is used as a reference for determining the toner level. CPU 50 accesses main body's built-in non-volatile memory 60 to read this data, for use in waveform determining unit 101.

Motor control unit 102 outputs to drive motor 330 control instructions for driving or stopping toner bottle 301. Motor control unit 102 communicates with waveform determining unit 101 so as to control drive motor 330 in accordance with the communication result. When receiving a drive instruction from motor control unit 102, drive motor 330 drives toner bottle 301.

Waveform detecting unit 103 detects a waveform (or, a current waveform) of the current flowing through drive motor 330 while drive motor 330 is being driven. The current waveform detected by waveform detecting unit 103 is transmitted to waveform determining unit 101.

Waveform determining unit 101 determines the toner level in toner bottle 301 on the basis of the current waveform received from waveform detecting unit 103. Waveform determining unit 101 reads a load determination current waveform stored in data storing unit 104, for example. Waveform determining unit 101 then compares the current waveform detected by waveform detecting unit 103 with the load determination current waveform, to determine whether the toner level is high or low.

If waveform determining unit 101 determines that the toner level is high, motor control unit 102 continues normal control.

If waveform determining unit 101 determines that the toner level is low, waveform determining unit 101 instructs panel 600 to display a message prompting a user to prepare a new toner bottle.

### [Configuration for Detecting Toner Level in Hopper]

A configuration for detecting the toner level in hopper 342 will now be described.

When the toner in toner bottle 301 is consumed completely as it is replenished to development device 350, the toner in hopper 342 is consumed. As the toner level in hopper 342 decreases, the weight of hopper 342 decreases correspondingly, leading to a reduction in magnitude of the load applied to drive motor 340 which is rotating the agitator in hopper 342. This allows CPU 50 to detect the toner level in hopper 342 on the basis of a waveform of the current flowing through drive motor 340. When the toner in hopper 342 is consumed completely, no toner remains in the image forming device, making image forming device 1 unable to form images. Thus, in the case where the toner level in hopper 342 is a predetermined level or less, CPU 50 causes a message prompting a user to replace the toner bottle to be displayed.

FIG. 8 is a block diagram showing a configuration for detecting a waveform of the current flowing through a toner hopper drive motor to confirm the toner level in the hopper, and for displaying a message regarding replacement of the toner bottle to a user.

Referring to FIG. 8, CPU 50 includes a motor current waveform determining unit (hereinafter, also referred to as “waveform determining unit”) 111, a toner hopper drive motor control unit (hereinafter, also referred to as “motor control unit”) 112, and a motor current waveform detecting unit (hereinafter, also referred to as “waveform detecting unit”) 113.

Main body's built-in non-volatile memory 60 includes a motor current waveform comparison data storing unit (hereinafter, also referred to as “data storing unit”) 114. Data storing unit 114 stores data of a load determination current waveform. CPU 50 accesses main body's built-in non-volatile memory 60 to read this data, for use in waveform determining unit 111.

It is noted that data storing unit 114 may store the load determination current waveform which is the same as, or different from, that stored in data storing unit 104 shown in FIG. 7.

Motor control unit 112 outputs to drive motor 340 control instructions for driving or stopping hopper 342. Motor control unit 112 communicates with waveform determining unit 111 so as to control drive motor 340 in accordance with the communication result. When receiving a drive instruction from motor control unit 112, drive motor 340 drives hopper 342.

Waveform detecting unit 113 detects a waveform (or, a current waveform) of the current flowing through drive motor 340 while drive motor 340 is being driven. The current waveform detected by waveform detecting unit 113 is transmitted to waveform determining unit 111.

Waveform determining unit 111 determines the toner level in hopper 342 on the basis of the current waveform received from waveform detecting unit 113. Waveform determining unit 111 reads a load determination current waveform stored in data storing unit 114, for example. Waveform determination unit 111 then compares the current waveform detected by waveform detecting unit 113 with the load determination current waveform, to determine whether the toner level is high or low.

If waveform determining unit 111 determines that the toner level is high, motor control unit 112 continues normal control.

If waveform determining unit 111 determines that the toner level is low, waveform determining unit 111 instructs panel 600 to display a message prompting a user to replace the toner bottle. It is noted that either one of the configurations shown in FIGS. 7 and 8 alone may be included in the image forming device.

### [First Method for Detecting Toner Level]

A method for detecting the toner level in a toner bottle or in a hopper will now be described.

In this first method, load (or load variation) of a stepper motor for a toner bottle or for a hopper is detected on the basis of a shape of the waveform of the current flowing through the stepper motor, and the toner level in the toner bottle or in the hopper is detected on the basis of the load.

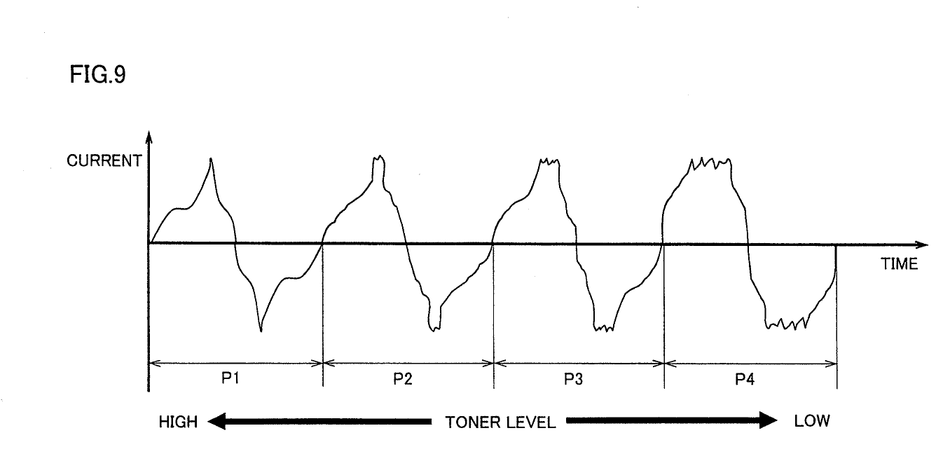

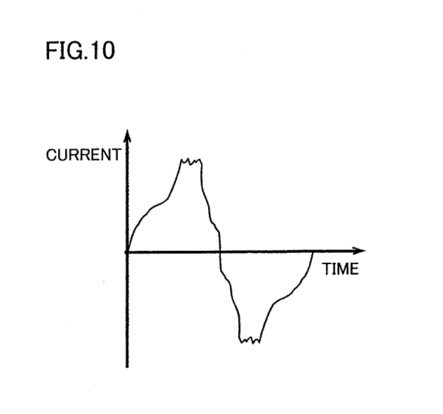

FIG. 9 shows, by way of example, changes over time of the current waveform detected while the stepper motor is being driven. FIG. 10 schematically shows a load determination current waveform.

Referring to FIG. 9, changes of the current waveform with decreasing toner level in the toner bottle or in the hopper as the toner is gradually consumed are shown schematically. The current waveform during a period P1 shows the current waveform in the state where the toner level in the toner bottle or in the hopper is the highest. As the toner is consumed gradually, the current waveform detected changes over a lapse of time from period P1 to period P2, to period P3, and to period P4.

Under the circumstances, the load determination current waveform shown in FIG. 10 is used to determine whether a current waveform detected (which changes over time) has a shape closer (or, similar) to the shape of the current waveform on the maximum load side or the shape of the current waveform on the minimum load side. In other words, if the detected current waveform is closer in terms of shape to the current waveform on the maximum load side (FIG. 4) than to the load determination current waveform shown in FIG. 10, it is determined that the load is heavy. On the other hand, if the detected current waveform is closer in terms of shape to the current waveform on the minimum load side (FIG. 5) than to the load determination current waveform shown in FIG. 10, it is determined that the load is light. When it is determined that the load is light, it means that the toner level is low, so that a predetermined message is displayed on panel 600.

In comparing the current waveforms with each other, shapes of the current waveforms (or, current values) with respect to time may be compared directly. Alternatively, cumulative electric power or cumulative electric current of each current waveform may be calculated and used for comparing the current waveforms with each other.

### [Second Method for Detecting Toner Level]

As a way of detecting the toner level in a toner bottle or in a hopper, the following second method may be used in place of the first method described above.

In the second method, an inflection point is detected (recognized) from the rising edge of a waveform (or, a current waveform) of the current that flows through the stepper motor as the motor is operated, and load (or load variation) is detected on the basis of the inflection point.

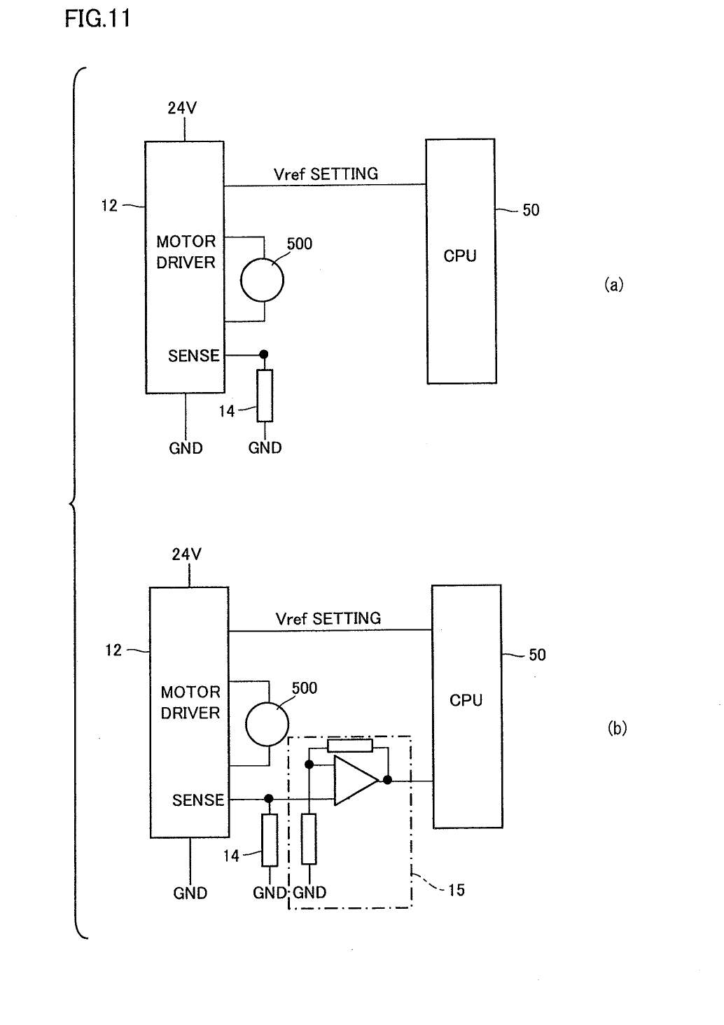

FIG. 11 shows a stepper motor drive circuit included in device control unit 40. In FIG. 11, (a) is an equivalent circuit diagram of a part of a typical two-phase stepper motor drive circuit, and (b) shows a stepper motor drive circuit included in device control unit 40.

Referring to FIG. 11(a), it is here assumed that a two-phase bipolar type stepper motor is to be driven. A stepper motor 500 corresponds for example to drive motor 330 or drive motor 340. Stepper motor 500 is connected to a motor driver (IC) 12, and rotates in accordance with an excitation signal from motor driver 12.

Motor torque is set by varying a voltage at a Vref terminal of motor driver 12. In FIG. 11(a), it is configured such that Vref is output from CPU 50. Vref may be set by resistance division.

Motor driver 12 is provided with a SENSE terminal for detecting a waveform of the current flowing through the motor. The SENSE terminal is electrically connected with a resistor for sensing current 14.

Referring to FIG. 11(b), in the present embodiment, device control unit 40 includes a circuit 15 for inputting a voltage across resistor 14 to CPU 50, thereby enabling recognition of the rising edge of the current flowing through the motor.

More specifically, the SENSE terminal is used for detecting an inflection point of the current flowing through the motor. Measuring the voltage across resistor 14 at prescribed time intervals makes it possible to obtain a rate of change of the current. From this current change rate, it is possible to determine the presence or absence of an inflection point, and if any, at what percent of the set current the inflection point occurred.

Measuring the voltage across resistor 14 at the prescribed time intervals further makes it possible to determine at what number of times of sampling the inflection point occurred. This also enables calculation of the time taken from the phase switching of the stepper motor to the occurrence of the inflection point. These pieces of information are used to recognize the position where an inflection point occurs.

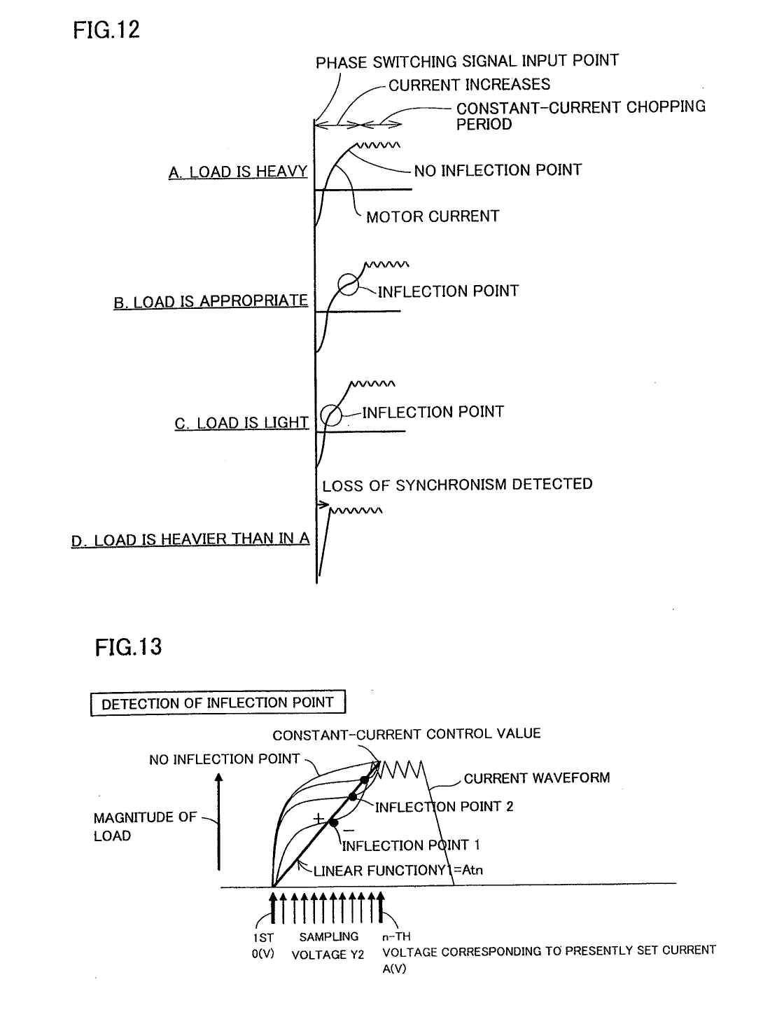

FIG. 12 illustrates how an inflection point occurs in accordance with load.

In FIG. 12, graphs in A to D each show how the motor current reaches a constant-current period (or, the constant-current chopping period). In the graphs, the horizontal axis represents time, and the vertical axis represents current.

When an excitation signal is input and current starts to flow through a motor coil, the motor current rises as shown in the figure. The current change rate, which is small immediately after the input of the excitation signal, would increase gradually and then decrease as the motor current approaches the constant-current period. Once the motor current has increased to a set current level, the motor current is repeatedly turned ON and OFF so as to maintain the set current level. While the current change rate takes a positive value in the waveforms shown in FIG. 12, the current may decrease depending on a motor or load.

In the present embodiment, load applied to a motor is estimated by focusing on the point (i.e. the “inflection point”) at which the current change rate changes significantly.

If the load is light for the motor output (C in FIG. 12), an inflection point occurs at a position distant from the constant-current period. As the load is increased, the position of occurrence of an inflection point approaches the constant-current period (B in FIG. 12). In the case where the motor is rotating with excess torque (well within the capacity), the greater the surplus, the farther from the constant-current period the position of occurrence of an inflection point becomes, and the shorter the time taken from the phase switching to the initiation of the constant-current period becomes.

As the load is further increased, no inflection point occurs before the motor current reaches the constant-current period (A in FIG. 12). Under heavy load, a current waveform would likely have a wide curve until it reaches an inflection point. With the current waveform of A in FIG. 12, the motor current reaches the set current (the constant current) where constant-current chopping is started, without occurrence of an inflection point. In this case, the time taken from the phase switching to the initiation of the constant-current period becomes short, in spite of the heavy load. Although a motor may rotate with no inflection point, this is not a condition where the motor is rotating while securing proper safety margin. Measuring the time taken from the phase switching to the initiation of the constant-current period makes it possible to estimate the condition where the motor is rotating.

As the load is further increased from the state of A in FIG. 12, the time taken for the motor current to reach the constant-current period shortens, as shown in D in FIG. 12. This indicates a condition where the motor output is too small for the load. In this case, the motor is rotating in an unreliable state with insufficient motor output for the load.

The position of occurrence of an inflection point that ensures stable rotation of a motor with respect to given load can be designed optimally in accordance with the characteristics of the load (for example, whether an abrupt load variation takes place during a constant rotation, or the like).

FIG. 13 illustrates a specific example of a method for detecting an inflection point. In FIG. 13, a waveform of current flowing through a motor and a linear function for detecting an inflection point are shown. As described above, the position of occurrence of an inflection point approaches the constant-current period as the motor load becomes heavier. In FIG. 13, four types of curves of the current waveform until the motor current reaches a constant-current control value are shown by way of example. Comparing the current waveform curve with an inflection point 1 and the current waveform curve with an inflection point 2, the one with the inflection point 2 corresponds to heavier load.

As the motor current flows through resistor 14 (FIG. 11(b)), a voltage waveform approximately the same as the motor current waveform appears on the SENSE terminal. This waveform may be used for measuring the current waveform (i.e., the voltage waveform may be used as an equivalent to the current waveform). Alternatively, a signal that varies in a manner similar to the current waveform may be used for measuring the current waveform.

For detecting an inflection point, firstly, a linear function (the “linear function” in the figure) connecting the position where the current (or the voltage) rises from 0 and the position where the constant-current period starts is obtained. The starting position of the constant-current period and the constant-current control value may be obtained from the result of detection of an inflection point previously measured.

It is here assumed that the obtained linear function is: Y1 (n)=Atn.

In actual motor control, a rising waveform of the voltage is sampled n times, and the result is set as Y2 (n).

The position where Y2 (n)−Y1 (n) becomes 0 or the position where the ±polarities change can be identified, and this position can be recognized as an inflection point. If a distance of this inflection point from the constant-current period is greater than that of a reference inflection point which has been set on the basis of the load determination current waveform, it is determined that the load is light. On the other hand, if the distance of this inflection point from the constant-current period is shorter than that of the reference inflection point, it is determined that the load is heavy. It is noted that the motor load may be determined by measuring the time taken from the phase switching to the initiation of the constant-current period.

If Y2 (n)−Y1 (n) becomes 0 at any position, or if the ±polarities do not change, no inflection point would occur, in which case it may be determined to be loss of synchronism. Further, whether the motor load value is greater or smaller than a designed value can be determined on the basis of the position of occurrence of an inflection point. Thus, the current to be flown through the motor may be changed in accordance therewith. That is, the load determination result may be fed back to the motor control. More specifically, the current to be flown through the motor may be increased when the load is heavy, and may be decreased when the load is light. With this control, the motor current can be maintained at a proper level, leading to energy saving.

If it is determined that the load is light, it means that the toner level is low. In this case, a predetermined message is displayed on panel 600.

### [Flowchart of Toner Level Detecting Process]

A process of detecting the toner level (or, a process of detecting the load on a stepper motor) performed by the device control unit in the image forming device will now be described. This process is implemented as CPU 50 in device control unit 40 executes a program.

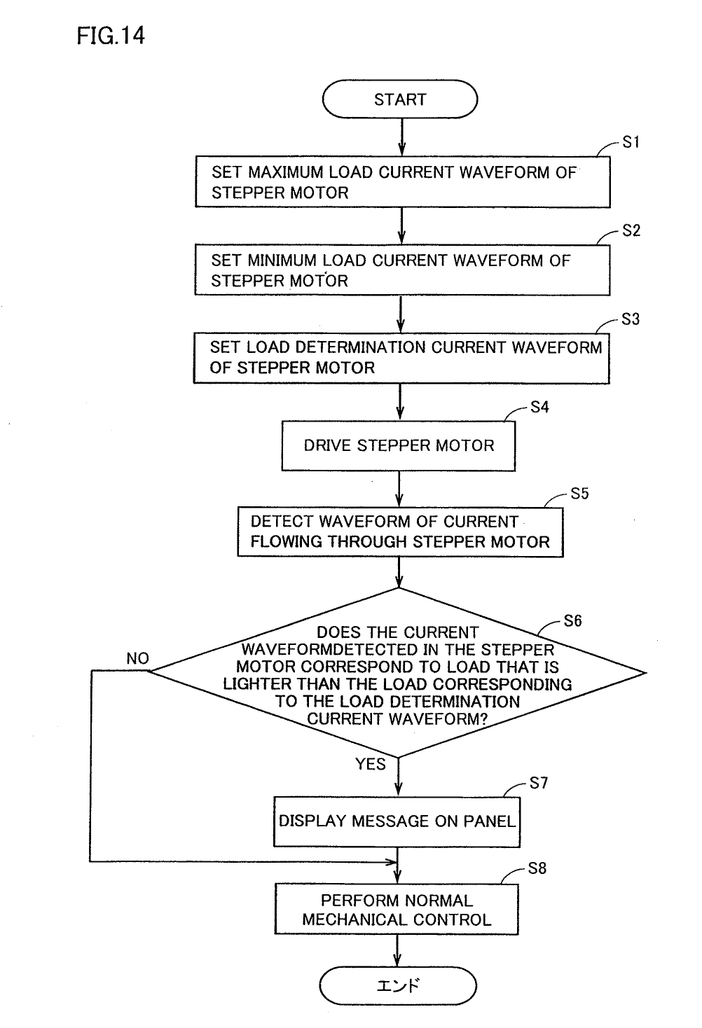

FIG. 14 is a flowchart of the toner level detecting process.

Referring to FIG. 14, CPU 50 sets a maximum load current waveform of a stepper motor, which may be drive motor 330 for toner bottle 301 or drive motor 340 for hopper 342 (S1), and stores the same in main body's built-in non-volatile memory 60. Next, CPU 50 sets a minimum load current waveform of the stepper motor (S2), and stores the same in main body's built-in non-volatile memory 60. Next, CPU 50 sets a load determination current waveform of the stepper motor (S3), and stores the same in main body's built-in non-volatile memory 60. Next, CPU 50 causes current to flow through the stepper motor to drive the stepper motor, so as to drive a corresponding component in image forming device 1 by the motive power (S4). Then, CPU 50 detects a waveform of the current flowing through the stepper motor while the motor is being driven (S5). CPU 50 then compares the current waveform detected in the stepper motor with the current waveform (i.e. the load determination current waveform) for use in determining the magnitude of the load, to determine whether the current waveform detected in the stepper motor corresponds to load that is lighter than the load corresponding to the load determination current waveform (S6). If so (YES in S6), CPU 50 determines that the toner level is low, and displays a predetermined message to the user on panel 600 (S7). Thereafter, CPU 50 performs normal mechanical control (S8), and the process is terminated.

If it is determined in step S6 that the current waveform detected in the stepper motor corresponds to load that is heavier than the load corresponding to the load determination current waveform (NO in S6), CPU 50 performs normal mechanical control (S8) without displaying any message, and the process is terminated.

### Effects of the Embodiment

The image forming device according to the present embodiment includes a stepper motor, a component which is driven using the stepper motor, a unit to set a maximum load current waveform, a minimum load current waveform, and a load determination current waveform of the stepper motor, and a unit to detect a waveform of the current flowing through the stepper motor. The current of the stepper motor is set such that the current waveform thereof changes significantly between the state where maximum load is applied to the motor and the state where minimum load is applied to the motor when the motor drives a component. The image forming device is configured to detect the magnitude of the load that the stepper motor is driving, on the basis of a waveform of the current flowing through the stepper motor.

For example, in an image forming device which uses a stepper motor to rotate a component, the condition of the component as a load can be determined on the basis of a change in the waveform of the current flowing through the stepper motor, and a message can be displayed to a user on the basis of the determination result, or the determined load condition can be fed back to the control of the image forming device.

According to image forming device 1 of the present embodiment, it is possible to determine the condition (or, weight) of a component as a load by comparing the current waveform, which changes in accordance with the magnitude of the load, with the load determination current waveform, to thereby control the device. This allows a message to be displayed to a user at an appropriate time, without the need to stop printing, for example. Further, the load can readily be determined, without using an additional sensor or the like, which can minimize an increase in the cost of the device.

In a high-grade office MFP as an example of the image forming device, a user may wish to replace the toner bottle during printing. In such a case, a message for prompting a user to prepare a new toner bottle may be displayed when it is determined on the basis of the motor load that the toner bottle is running out of toner. As a result, it is possible to adopt the configuration which enables replacement with a new toner bottle even during printing.

Conventionally, an integrated circuit (IC) would be installed in a toner cartridge including a toner bottle to detect an unused state of the toner bottle and to estimate the toner level therein in accordance with the number of rotations of the toner bottle from the unused state. In the future, however, a toner cartridge may be provided with no IC for the purposes of saving cost. The present embodiment offers an effective way of detecting the toner level in a toner bottle even in a toner cartridge provided with no IC.

### [Others]

In the embodiment described above, the method for detecting the toner level in toner bottle 301 or in hopper 342 on the basis of a waveform of the current flowing through the motor for toner bottle 301 or for hopper 342 has been described. The present invention however is not restricted to the above-described case. What is essential is to determine the condition of the image forming device on the basis of the motor current waveform. For example, a current waveform of the current flowing through any one of the motors for driving the components in image forming device 1, such as main motor 501, fixing motor 502, black development motor 503, color development motor 504, or color photoreceptor motor 505 shown in FIG. 1, may be used to detect load applied to the motor while the motor is being driven, and the condition of image forming device 1 may be determined in accordance therewith. Then, on the basis of the determined condition, the image forming device may be controlled and/or a message may be displayed to a user.

In the embodiment described above, it is assumed that the toner in toner bottle 301 is supplied to development device 350 via hopper 342. The present invention however is not restricted thereto; the hopper does not necessarily have to be included in the image forming device. In the absence of a hopper, the toner in toner bottle 301 may be supplied directly to development device 350.

The processes according to the above embodiment may be performed by software or by using a hardware circuit.

A program for executing the processes according to the above embodiment may be provided as well. The program may be recorded on a recording medium, such as a CD-ROM, flexible disk, hard disk, ROM, RAM, memory card, or the like, so as to be provided to a user. The program is executed by a computer such as a CPU. The program may also be downloaded to the device via a communication line such as the Internet.

According to the image forming device and the method for controlling the image forming device in the above-described embodiment, it is possible to determine the condition of the image forming device while suppressing an increase in the number of components and preventing reduction of productivity.

Although the preset invention has been described and illustrated in detail, it is clearly understood that the same is by way of illustration and example only and is not to be taken by way of limitation, the spirit and scope of the present invention being limited only by the terms of the appended claims.

What is claimed is:

1. An image forming device including at least one motor configured to generate motive power by current, the image forming device comprising:
a component driven by the motive power of said motor; and
a determining unit configured to determine a condition of said image forming device on the basis of a current waveform of current flowing through said motor while said motor is being driven.

2. The image forming device according to claim 1, wherein said motor is a stepper motor.

3. The image forming device according to claim 1, wherein said current waveform in the state where load applied to said motor while said motor is driving said component is maximum and said current waveform in the state where said load is minimum are different from each other.

4. The image forming device according to claim 3, further comprising:
a first setting unit to set said current waveform corresponding to the case where said load has a reference magnitude;
a second setting unit to set said current waveform corresponding to the case where said load has a magnitude greater than said reference magnitude;
a third setting unit to set said current waveform corresponding to the case where said load has a magnitude smaller than said reference magnitude; and
a detecting unit to detect said current waveform; wherein
said determining unit detects said load by determining, with reference to said current waveform corresponding to the case where said load has said reference magnitude, whether said current waveform has a shape that is closer to a shape of said current waveform corresponding to the case where said load has a magnitude greater than said reference magnitude or to a shape of said current waveform corresponding to the case where said load has a magnitude smaller than said reference magnitude.

5. The image forming device according to claim 1, wherein
said component includes a toner bottle for storing toner for use in image formation, and
said determining unit detects the toner level in said toner bottle on the basis of a current waveform of the current flowing through the motor that is driving said toner bottle.

6. The image forming device according to claim 5, wherein in the case where said toner level in said toner bottle is a predetermined level or less, said determining unit displays, on a panel used for displaying a message to a user, a message prompting the user to prepare a new toner bottle.

7. The image forming device according to claim 1, wherein
said component includes a hopper for relaying toner being supplied, and
said determining unit detects the toner level in said hopper on the basis of a current waveform of the current flowing through the motor that is driving said hopper.

8. The image forming device according to claim 7, wherein in the case where said toner level in said hopper is a predetermined level or less, said determining unit displays, on a panel used for displaying a message to a user, a message prompting the user to replace a toner bottle with a new one.

9. The image forming device according to claim 1, wherein said determining unit detects load applied to said motor while said motor is driving said component, on the basis of a shape of said current waveform.

10. The image forming device according to claim 1, further comprising an inflection point recognizing unit configured to recognize an inflection point from a rising edge of said current waveform, wherein
said determining unit detects load applied to said motor while said motor is driving said component, on the basis of said inflection point.

11. A method for controlling an image forming device including at least one motor configured to generate motive power by current, the method comprising steps of
causing said motor to generate the motive power by the current to drive a component by the motive power of said motor; and
determining a condition of said image forming device on the basis of a current waveform of current flowing through said motor while said motor is being driven.

12. The method for controlling the image forming device according to claim 11, wherein said motor is a stepper motor.

13. The method for controlling the image forming device according to claim 11, wherein said current waveform in the state where load applied to said motor while said motor is driving said component is maximum and said current waveform in the state where said load is minimum are different from each other.

14. The method for controlling the image forming device according to claim 13, further comprising steps of:
setting said current waveform corresponding to the case where said load has a reference magnitude;
setting said current waveform corresponding to the case where said load has a magnitude greater than said reference magnitude;
setting said current waveform corresponding to the case where said load has a magnitude smaller than said reference magnitude; and
detecting said current waveform; wherein
said determining step includes a step of detecting said load by determining, with reference to said current waveform corresponding to the case where said load has said reference magnitude, whether said current waveform has a shape that is closer to a shape of said current waveform corresponding to the case where said load has a magnitude greater than said reference magnitude or to a shape of said current waveform corresponding to the case where said load has a magnitude smaller than said reference magnitude.

15. The method for controlling the image forming device according to claim 11, wherein
said component includes a toner bottle for storing toner for use in image formation, and
said determining step includes a step of detecting the toner level in said toner bottle on the basis of a current waveform of the current flowing through the motor that is driving said toner bottle.

16. The method for controlling the image forming device according to claim 15, wherein said determining step includes a step of, in the case where said toner level in said toner bottle is a predetermined level or less, displaying on a panel used for displaying a message to a user, a message prompting the user to prepare a new toner bottle.

17. The method for controlling the image forming device according to claim 11, wherein
said component includes a hopper for relaying toner being supplied, and
said determining step includes a step of detecting the toner level in said hopper on the basis of a current waveform of the current flowing through the motor that is driving said hopper.

18. The method for controlling the image forming device according to claim 17, wherein said determining step includes a step of, in the case where said toner level in said hopper is a predetermined level or less, displaying on a panel used for displaying a message to a user, a message prompting the user to replace a toner bottle with a new one.

19. The method for controlling the image forming device according to claim 11, wherein said determining step includes a step of detecting load applied to said motor while said motor is driving said component, on the basis of a shape of said current waveform.

20. The method for controlling the image forming device according to claim 11, further comprising a step of recognizing an inflection point from a rising edge of said current waveform, wherein
said determining step includes a step of detecting load applied to said motor while said motor is driving said component, on the basis of said inflection point.
